(19) United States
(12) Patent Application Publication
(10) Pub. No.: US 2008/0113739 A1
(43) Pub. Date: May 15, 2008

(54) Gaming Machine With Split Symbols

(76) Inventors: Antoon Visser, New South Wales (AU); Edgar Pau, New South Wales (AU); Mark Sinosich, New South Wales (AU); Adrian Watson, New South Wales (AU)

Correspondence Address: MCANDREWS HELD & MALLOY, LTD, 500 WEST MADISON STREET, SUITE 3400, CHICAGO, IL, 60661, US

(21) Appl. No.: 11/574,196

(22) PCT Filed: Aug. 24, 2005
(86) PCT No.: PCT/AU05/01231

§ 371 Date: Jul. 26, 2007

(30) Foreign Application Priority Data
Aug. 24, 2004 (AU) 2004904913

(51) Int. Cl. A63F 13/00

(52) U.S. Cl. 463/20

(57) ABSTRACT

A method of operating a gaming machine/a gaming machine (10) comprising a display (14), a game controller (36) to control the play of the game, and control images displayed on the display, the game is a spinning reel game (FIG. 3) comprising a plurality of symbols that are separated into a plurality of symbol sets (FIG. 9), each set of symbols is associated with a distinct reel, a combined symbol is defined by the combination of a symbol from one symbol set with at least one symbol from at least one other symbol set but not with at least some other symbols from the at least one other symbol set (62, 64), during the play of the game, representations of the game are displayed on the display showing a random selection of plurality of symbols from each symbol set and prize is awardable only when a matching combined symbol (52, 54, 56, 58, 62, 64) is displayed on the display.

### FIELD OF THE INVENTION

This invention relates to a gaming machine. More particularly, the invention relates to a gaming machine, a game played on such a gaming machine and a method of operating a game playing apparatus.

### BACKGROUND TO THE INVENTION

Players who regularly play gaming machines quickly tire of particular games. Therefore it is necessary for manufacturers of these machines to develop innovative game features which add interest to the games. In so doing, it is hoped to keep players amused and therefore willing to continue playing the game as well as to attract new players.

Also, with the growth that has occurred in the gaming machine market, there is intense competition between manufacturers to supply various existing and new venues. When selecting a supplier of gaming machines, the operator of a venue will often pay close attention to the popularity of various games with their patrons. Therefore, gaming machine manufacturers are keen to devise games and/or game features which are popular with the players as a mechanism for improving sales, retaining customers and attracting new customers.

Still further, players are becoming increasingly familiar with spinning reel games or games on which symbols are displayed on a display. Therefore, it would be beneficial to provide enhanced technical effects to heighten player enjoyment and the player's sense of anticipation.

It is therefore an object of the present invention to provide a gaming machine, a game for play on a gaming machine and/or a method of controlling a gaming apparatus that provides a new player to gaming machine interaction and/or a new method for establishing whether a prize is awarded to a player of a gaming machine.

Is it is an alternative object of the present invention to provide a gaming machine, a game for play on a gaming machine and/or a method of controlling a gaming apparatus that at least provides the public with a useful alternative.

### SUMMARY OF THE INVENTION

Throughout the specification, unless the context clearly requires otherwise, the term “comprise” and variations on this term including “comprising” and “comprises” are to be understood to imply the inclusion of a feature, integer, step or element, and not to exclude other features, integers, steps or elements.

According to a first aspect of the present invention, there is provided a gaming machine comprising a display and a game controller to control play of a game on the gaming machine and control images displayed on the display in accordance with the game, the game comprising a plurality of symbols that are separated into a plurality of symbol sets, wherein for each symbol set a combined symbol is defined by the combination of a symbol from that symbol set with at least one symbol from at least one other symbol set but not with at least some other symbols from the at least one other symbol set, wherein during play of the game representations of the game are displayed on the display showing a random selection of at least one symbol from each symbol set, and wherein a prize is awardable only when at least one combined symbol is displayed on the display.

Preferably, the number of symbol sets is at least a factor of two of the number of symbols that form a combined symbol and a prize is awarded only when a plurality of combined symbols are displayed on the display.

Preferably, the game is a spinning reel game in which at least one symbol from a first symbol set of said plurality of symbol sets is spun up a first reel and at least one symbol from a second symbol set of said plurality of symbol sets is spun up on a second reel. Each set of symbols may be associated with a distinct reel of the spinning reel game. At least two symbol sets may be spun up on the same reel with a combined symbol not being formed by any combination of symbols that are spun up on the same reel. Preferably, there are N reels and 2N−2 symbol sets, where N is an integer and N≧3. The game may have at least one pay line, wherein a prize is only awarded when said plurality of combined symbols are displayed on said at least one pay line.

Preferably, at least one of said plurality of symbols is a wildcard symbol and is deemed to form a combined symbol when displayed on said display with any other symbol of said plurality of symbols.

Preferably, the display of representations on the display showing a random selection of at least one symbol from each symbol set comprises showing at different times the selection for at least two symbol sets that can together form a combined symbol or a part thereof.

Preferably, the combined symbol is defined by the combination of two symbols and the plurality of symbol sets are separated into at least one pair of symbol sets, each pair of symbol sets consisting of a first set of symbols and a second set of symbols, and wherein a prize is awardable only when at least one combined symbol is displayed on the display, the combined symbol formed from two symbols within the same pair of symbol sets. The display of representations on the display showing a random selection of at least one symbol from said first set of symbols and a random selection of at least one symbol from said second set of symbols may occur sequentially for each of the pairs of symbol sets.

Alternatively, a combined symbol is defined by the combination of at least three symbols, each symbol belonging to a separate one of said plurality of symbol sets. A combined symbol may be defined by M symbols, and there are R symbol sets (R=nM, where n is an integer), and wherein the R symbol sets are divided into n groups and only symbols within the same group can form a combined symbol.

Preferably, a player of the gaming machine is allowed to select one or more of the combined symbols, wherein a prize is only awardable when at least one combined symbol that has been selected by the player is displayed on the display.

According to a second aspect of the present invention, there is provided a game to be played on a gaming machine comprising a display and a game controller to control play of the game on the gaming machine, control images displayed on the display in accordance with the game and award a prize on the occurrence of predetermined events during play of the game, the game comprising a plurality of symbols that are separated into a plurality of symbol sets, wherein for each symbol set a combined symbol is defined by the combination of a symbol from that symbol set with at least one symbol from at least one other symbol set but not with at least some other symbols from the at least one other symbol set, the game causing the controller to display representations of the game on the display showing a random selection of at least one symbol from each symbol set and causing the controller to award a prize when the predetermined events occur, wherein every event in the predetermined events involves the display of at least one combined symbol on the display.

Preferably, the plurality of symbol sets are separated into pairs of symbol sets and a combined symbol is defined by the combination of a symbol from one symbol set in the pair with at least one symbol from the other symbol set in the pair but not with at least some other symbols from said other symbol set.

Preferably, the game is displayed as a spinning reel type game, wherein each symbol set defines a reel strip for a spinning reel in the game.

According to a third aspect of the present invention, there is provided a method of operating a game playing apparatus comprising a display and a game controller to control play of a game on the gaming machine and control images displayed on the display in accordance with the game, the method comprising defining plurality of symbols that are separated into a plurality of symbol sets, defining a combined symbol as the combination of a symbol from one of said plurality of symbol sets with at least one symbol from at least one other symbol set but not with at least some other symbols from the at least one other symbol set, with every one of said plurality of symbol sets having symbols in it that can form a combined symbol in the game, randomly selecting at least one symbol from each symbol set and showing representations of the selection on the display, and awarding a prize only when at least one combined symbol is displayed on the display.

Preferably, the plurality of symbol sets are separated into pairs of symbol sets and a combined symbol is defined by the combination of a symbol from one symbol set in the pair with at least one symbol from the other symbol set in the pair but not with at least some other symbols from said other symbol set. The step of showing representations of the selection on the display may comprise showing representations of a spinning reel type game, wherein each symbol set defines a reel strip for a spinning reel in the game.

According to a fourth aspect of the present invention, there is provided a gaming machine comprising a display and a game controller to control play of a game on the gaming machine and control images displayed on the display in accordance with the game, the game comprising a plurality of symbols that are separated into at least a first set of symbols and a second set of symbols, at least one symbol in each set comprising a combined symbol that is displayed as two or more matching symbol parts and the remainder of the symbols in each set comprising symbols that are displayed as having at least two symbol parts that do not match, wherein during play of the game representations are displayed on the display showing a random selection of at least one symbol from each said set of symbols, and a prize is awardable only when at least one combined symbol is displayed on the display.

A combined symbol may be formed through a combination of two or more symbols from rows or columns of a matrix of displayed symbols. A combined symbol may be a “matching symbol” and in the preferred embodiment, to assist in maximising visual impact, the combined symbol is a matching symbol. However, this is not essential.

One of the symbols to be formed may be a special symbol. The special symbol may function as a substitute symbol. If a complete, special symbol is formed, the prize paid in respect of other complete, standard symbols which are formed may be increased. In other words, the special symbol may function as a substitute symbol for each complete, standard symbol that has been formed. A “standard” symbol is a symbol other than a special symbol.

Further, if a standard symbol is made up of, for example, one half of the standard symbol and one half of the special symbol, that may be regarded as a complete standard symbol of that type.

It will be appreciated that, a first part of each of a plurality of combined symbols may be displayed simultaneously at each of a plurality of the symbol positions with the remaining parts at those symbol positions being displayed with one another simultaneously as well. Thus, parts of the symbols may be carried on a first symbol carrier. The remaining parts may be carried on a second symbol carrier to be brought into position after the first symbol carrier has come to rest.

Thus, the invention extends also to a symbol carrier carrying at least one representation of a part of at least one symbol, the part of the at least one symbol being used, together with other parts of symbols, in determining whether or not a prize winning outcome has occurred.

The symbol carrier may be in the form of a reel, whether a mechanical reel or an electronic simulation of a reel.

In the various aspects of the invention, prizes may be paid for the number of occurrences of combined symbols, whether made up of matching parts or one part plus a part of the special symbol or complete wild symbols. Still further, prizes may be awarded for a predetermined number of occurrences of combined symbols formed.

In yet another embodiment of the invention, prizes may be awarded for the occurrence of combined symbols occurring on paylines. It will be appreciated that, where symbols are individually formed at each display location of a matrix of symbol positions, prizes may be awarded in respect of vertical paylines as well as horizontal, diagonal, zigzag or other irregularly shaped paylines.

The reel strips of a spinning reel game incorporating the present invention may not necessarily be of the same length as each other.

A game playing apparatus includes one which does not require the wagering of a stake in order to play the game and further includes apparatus which is connectable to a network.

### BRIEF DESCRIPTION OF THE DRAWINGS

Embodiments of the invention are now described by way of example with reference to the accompanying diagrammatic drawings in which:—

FIG. 1 shows a perspective view of a gaming machine, which is suitable for implementing a game in accordance with an embodiment of the invention;

FIG. 2 shows a block diagram of a control circuit of the gaming machine of FIG. 1;

FIG. 3 shows a screen display of a game result of a game in accordance with the present invention;

FIG. 4 shows a paytable applicable to an embodiment of a game in accordance with the present invention;

FIG. 5 shows a flow chart of the game of FIGS. 3 and 4;

FIG. 6 shows a paytable of another embodiment of a game in accordance with the present invention;

FIG. 7 shows a flow chart of the game of FIG. 6;

FIG. 8 shows a flow chart of yet a further embodiment of a game in accordance with the present invention;

FIG. 9 shows a table setting out reel strips of one embodiment of the game of the present invention;

FIG. 10 shows a screen display of yet a further embodiment of a game in accordance with the present invention;

FIG. 11 shows a table setting out reel strips of the game of FIG. 10;

FIG. 12 shows a screen display of still a further embodiment of a game in accordance with the present invention;

FIG. 13 shows a table setting out the reel strips applicable to the game of FIG. 12; and

FIG. 14 shows a table setting out reel strips of yet a further embodiment of the game in accordance with the present invention.

### DETAILED DESCRIPTION OF PREFERRED EMBODIMENTS

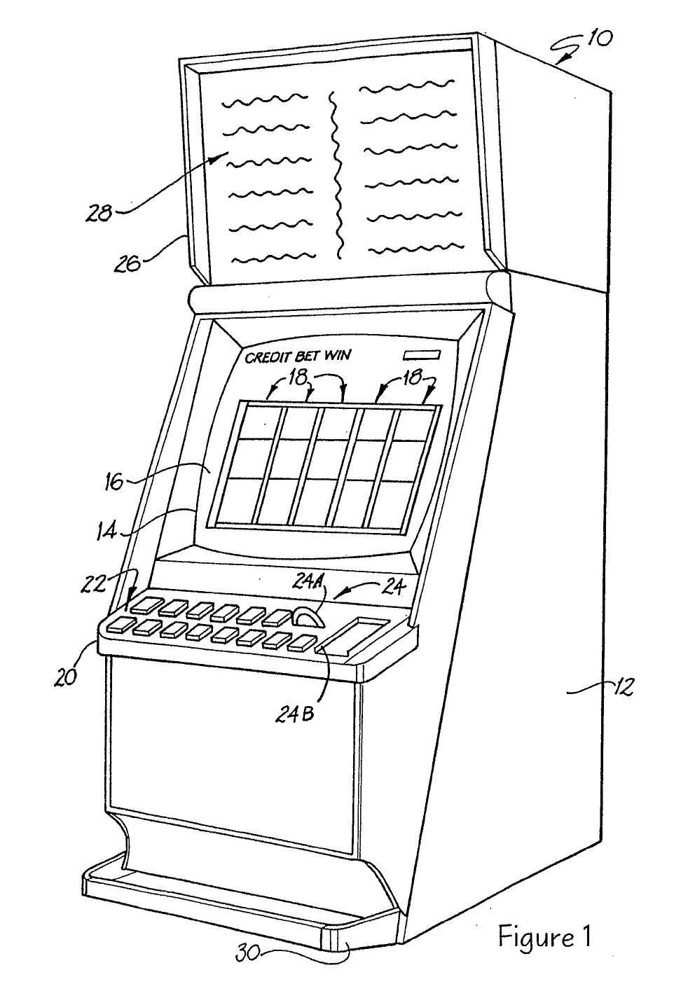

Referring to FIG. 1 of the accompanying drawings, a gaming machine generally referenced by arrow 10 is shown. The gaming machine 10 is an example of a gaming machine that is suitable to implement the present invention. The architecture of the gaming machine 10 includes a console 12 having a display 14 on which is displayed representations of a game 16 in accordance with the present invention, that can be played by a player. A mid-trim 20 of the gaming machine 10 houses a bank of buttons 22 for enabling a player to play the game 16. The mid-trim 20 also houses a credit input mechanism 24 including a coin input chute 24A and a bill collector 24B. A top box 26 may carry artwork 28, including for example, pay tables and details of bonus awards and other information or images relating to the game. A coin tray 30 is mounted beneath the console 12 for cash payouts from the gaming machine 10.

The display 14 shown in FIG. 1 is in the form of a video display unit, particularly a cathode ray tube screen device. Alternatively, the display 14 may be a liquid crystal display, plasma screen, any other suitable video display unit, or the visible portion of an electromechanical device. The top box 26 may also be a display, for example a video display unit, which may be the same type as the display 14, or a different type of display.

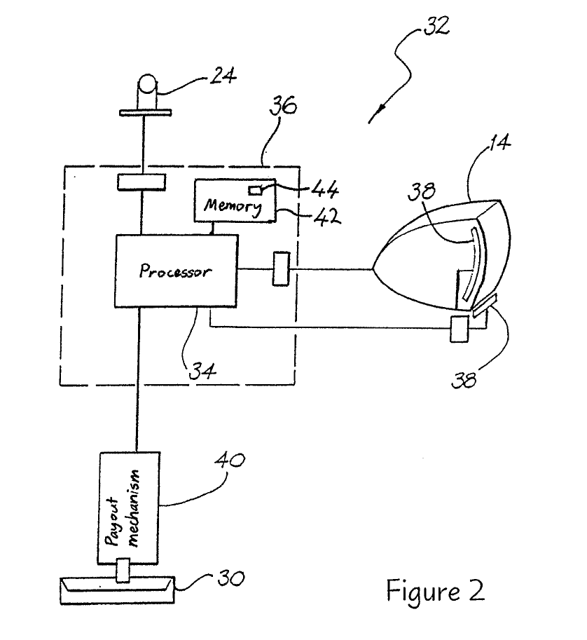

Referring now to FIG. 2 of the accompanying drawings, a simplified block diagram of a control circuit 32 for the gaming machine 10 is shown. The control circuit 32 includes a controller 36 having a processor 34, which is most suitably a computer processor, and associated computer readable memory 42. A program 44 stored in memory 42 contains instructions, that when executed by the processor 34 causes the controller 36 to implement the game 16 and drive the display 14. A set of sensors 38A are provided with the bank of buttons 22 to allow the controller 36 to determine when a player depresses one of the buttons in the bank of buttons 22. One or more further sensor 38B may be provided with the display 14, if the display 14 includes touch pads. Those skilled in the relevant arts will appreciate that the controller 36 may represent either a single device or a plurality of devices, which may be local or remote to each other. The controller 42 may be any suitable processor, microcontroller, programmable logic device or other suitable device for controlling a gaming machine. In addition, the memory 42 may be local or remote and may be formed by multiple memory parts.

The controller 36 also receives input signals from the credit input mechanism 24 to enable it to determine whether or not a player has provided sufficient credit to commence play of the game 16 and to enable a running total of a player's credit to be maintained. The controller 36 also drives a payout mechanism 40, which for example, may be a coin hopper for feeding coins to the coin tray 30 to make a pay out to a player when the player wishes to redeem his or her credit.

Those skilled in the relevant arts will appreciate that the gaming machine 10 may include many other components to perform functions such as additional computations, communications and monitoring of play. FIG. 2 and the associated description herein is provided only to give a background to the environment in which the present invention may be implemented.

Those skilled in the relevant arts will also appreciate that the architecture of the gaming machine 10 is only one example of a large number of possible alternative gaming machine architectures that may be used with the present invention. By way of example only, one architecture of a gaming machine is to have one or more displays, a user interface, a game controller and a transaction handling unit for accepting and paying credits or currency in some form, all located together in a single housing or in a plurality of physically connected housings. This is the architecture of the gaming machine 10. A second example architecture of a gaming machine is to have a display and a user interface located at a separate location from a game controller, wherein the game controller communicates with the display and the user interface through a fixed wire or wireless communication channel. A third example architecture of a gaming machine is to have a first and a second display, the second display being located separate from the first display and optionally shared by a plurality of gaming machines. The second display may be controlled by a separate controller from a controller for the first display, the two controllers being in communication with each other.

In other variations of the architecture of the gaming machine 10 the bank of buttons 22 may be omitted and reliance placed entirely on touch pads provided on the display 14, or vice versa. The credit input mechanism 24 may be a ticket reader, card reader, smart card reader, a communication interface with a personal mobile device, or any other type of validation device, either in addition to or instead of one or both of the coin input chute 24A and the bill collector 24B. Alternatively, where appropriate for the intended use of the gaming machine, a credit input mechanism may be omitted entirely. Similarly the pay out mechanism 40 may be ticket printer, card writer or other suitable device, or may be omitted entirely, with credits, for example, being communicated to a central database (not shown). As previously stated, the top box 26 may include a display, but it may also be omitted and if a second display is required it may be located separated from the console 12. A gaming machine, irrespective of its architecture is apparatus that allows a player to participate in a game of chance, irrespective of whether or not the apparatus requires the player to wager a stake in order to participate in the primary game.

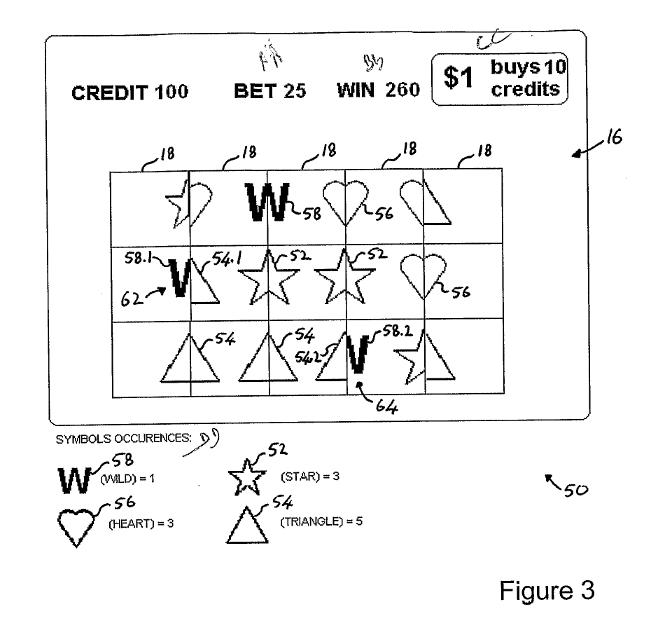

A first embodiment of a screen display 50 of the game 16 is shown in FIG. 3 of the drawings. The game 16 comprises five spinning reels 18. The game 16 has a plurality of symbols associated with it. For ease of explanation, the game 16 is described with reference to four symbols being three standard symbols of a star symbol 52, a triangle symbol 54 a heart symbol 56 and a special symbol which acts as a substitute or wild symbol 58. It will, of course, be appreciated that, in use, there are likely to be more than three standard symbols applicable to the game.

Each reel 18 carries only a part of each symbol 52-58 and, when the reels 18 stop spinning, a winning outcome which may occur is determined by the number of complete symbols 52-58 which are formed, as will be described in greater detail below.

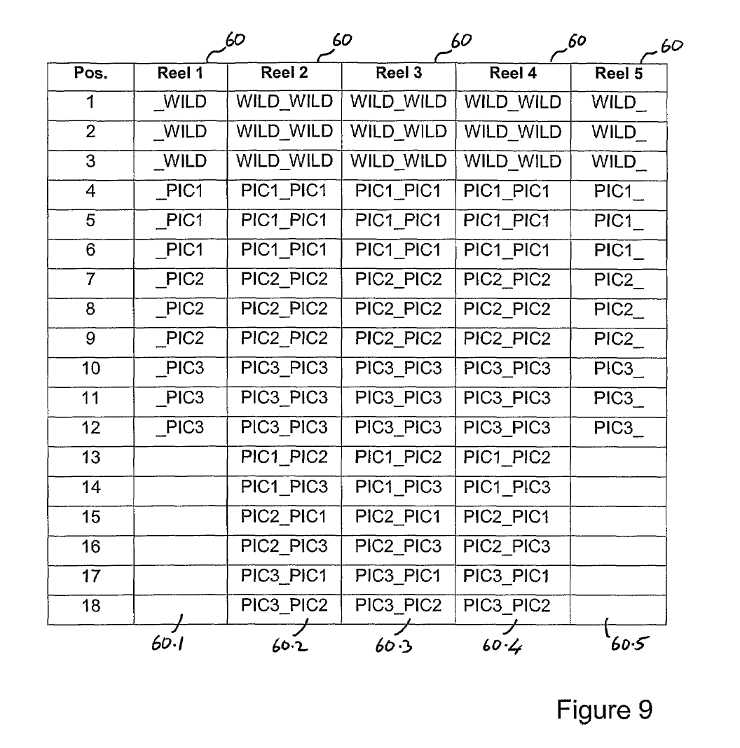

For the embodiment of the invention shown in FIG. 3 of the drawings, reel strips 60 applicable to the reels 18 are shown in FIG. 9 of the drawings. A first reel strip 60.1 has its left side (when viewed facing the screen 14 of the gaming machine) blank. The right reel strip 60.5 has its right side blank.

A right side of the first reel strip 60.1 carries a left half of the symbols 52-58 and a left side of the reel strip 60.5 carries a right half of the symbols 52-58. The second reel strip 60.2 carries a right half of the symbols 52-58 on a left side of the reel strip 60.2 and a left half of symbols 52-58 on a right side of the reel strip 60.2. The same applies in respect of reels strip 60.3 and 60.4. Thus, although the gaming machine 10 has five reels 18, an appearance of a four reel game is provided as shown in FIG. 3 of the drawings.

A complete symbol 52-58 is one in which left and right halves of the symbol match. Generally, a winning combination is the number of complete symbols 52-58 that are formed in paying positions. A prize awarded is given depending on the number of the same symbol required for a winning combination. A player can choose to buy one or more symbols, as will be described in greater detail below.

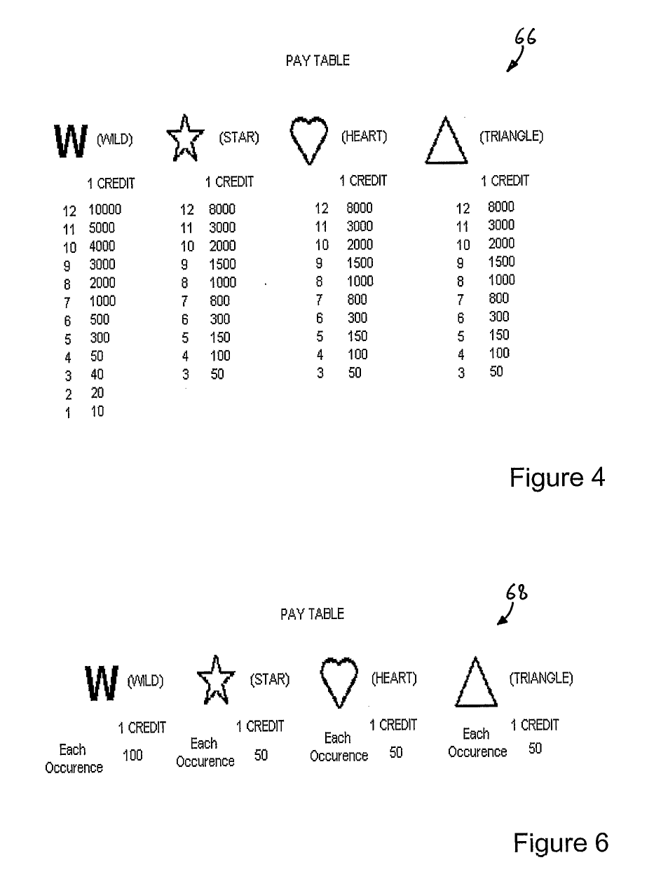

As indicated above, prizes are awarded for symbols 52-58 which are complete. In the embodiment shown in FIG. 3 of the drawings, a complete wild symbol 58 is shown in row one, column 2, and a prize of ten credits is paid for that occurrence, based on the paytable 66 shown in FIG. 4 of the drawings. In addition, a complete heart symbol 56 is formed at row 1, column 3 and also at row 2, column 4. Because of the presence of the complete wild symbol 58, a prize is awarded for three heart symbols 56, not two heart symbols 56. Similarly, two complete star symbols 52 occur in row 2, columns 2 and 3, respectively. Once again, because of the presence of the complete wild symbol 58, a prize is awarded for three star symbols.

A first complete triangle symbol 54 is formed in row three column 1 and a second, complete triangle symbol 54 appears at row three, column 2.

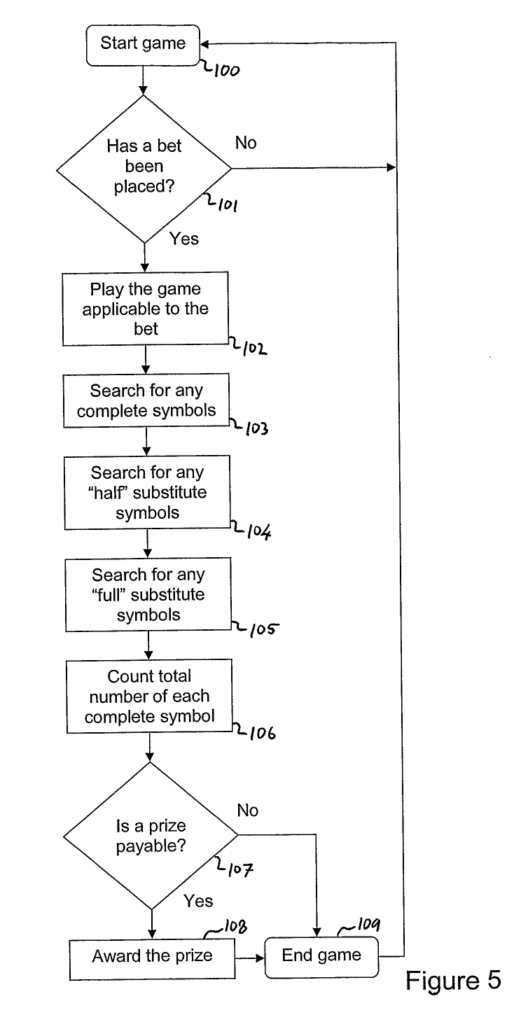

It is also to be noted that, in position 62, at row two, column 1, a combination of half a triangle symbol 54.1 and half a wild symbol 58.1 is formed. In position 64, a further half of a triangle symbol 54.2 is combined with a half of a wild symbol 58.2. The combinations at positions 62 and 64 are therefore regarded as complete triangle symbols 54 as well. Therefore, because of the presence of the complete wild symbol 58, the combinations of half a triangle and a half a wild symbol at positions 62 and 64 and the two complete triangle symbols, a prize is awarded for five triangle symbols. Thus, assuming the player were playing one credit, for the screen display 50 shown in FIG. 3 of the drawings, a total prize of 260 credits is payable to the player as determined from the paytable 66 in FIG. 4 of the drawings. A flow chart applicable to this version of this embodiment of the invention is shown in FIG. 5 of the drawings. Those skilled in the relevant arts will appreciate that the flow charts described herein show a method that may be readily realised in software. Those skilled in the relevant arts will also appreciate that the same results may be achieved using a variety of different methods and that the flow charts are provided for the purposes of explanatory example only.

The game starts at step 100 and cycles through decision step 101 to determine whether a player of the game 16 has placed a bet. If a bet has been placed, the game 16 plays the game that is applicable to the bet (step 102). In this example, the game 16 allows a bet on the occurrence of any complete symbols. As is explained herein below alternative bets may also be allowed. In step 103 the gaming machine controller 36 determines whether any complete symbols have been displayed on the display 14 and records the number of each type of complete symbol that has been displayed. In step 104 the controller 36 determines whether any special symbols that act as half substitute symbols have been displayed and then records the number of each type of half symbol that the special symbols have been displayed with. In step 105 the controller determines whether any a complete symbol is formed by two special symbols and then records the number of special symbols that have been displayed.

In step 106 the controller 36 determines the number of complete symbols of each type that have been formed and then in step 107 compares this with the paytable to determine whether a prize is awardable. If the prize is awardable, a prize is awarded in step 108, the value of the prize determined by the paytable applicable to the game 16. The game then ends at step 109, ready for the start of the next game. If in sufficient complete symbols of any type have been formed to pay a prize, then the game ends at step 109 without awarding any prize.

The most preferred embodiment of the invention is a spinning reel type game where a complete symbol is formed by two matching symbols. This embodiment is anticipated to provide a high level of visual impact, due in part to its simplicity. However, a paying symbol may be a combined symbol of any type, whether the symbols that form the combined symbol visually match or not. Furthermore, where a matrix, array or similar format is used instead of a spinning reel game format, a combined symbol may be formed by three or more symbols.

In another embodiment of the invention, a paytable 68 (FIG. 6) is applicable to the game 16. In this case, each complete symbol 52-58 pays a fixed prize as shown in the paytable 68. As in the case of the previous embodiment, where a half of one of the symbols 52-56 is combined with half of the wild symbol 58, such a combination is regarded as a complete symbol.

Therefore, in this embodiment of the invention, if the game results in the display shown in FIG. 3, one complete wild symbol 58 occurs, three complete star symbols 52 occur, three complete heart symbols 56 occur and five complete triangle symbols 54 occur, a prize of 650 is awarded as determined from the paytable 68 of FIG. 6.

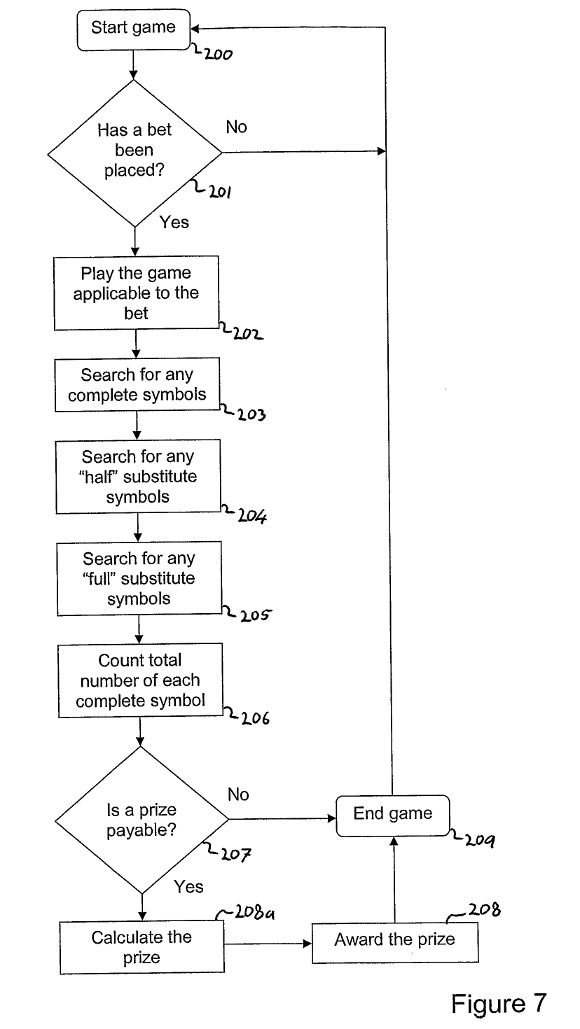

A flow chart applicable to this example of this embodiment of the invention is shown in FIG. 7 of the drawings. Steps 200 to 209 are similar to the corresponding steps 100 to 109 of FIG. 5. The difference lies in the calculation of the prize, which is represented by step 108a shown in FIG. 7.

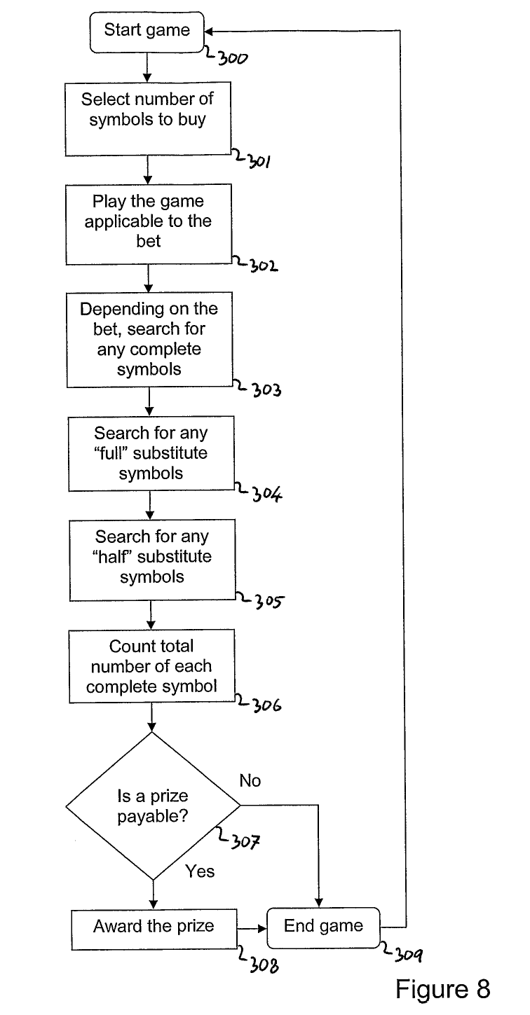

In yet a further example of this embodiment of this invention, the player may choose to buy a predetermined number of the symbols 52-58. For example, one credit buys all symbol 52 wins only, five credits buys all symbols 52 and 54 wins only; ten credits buys all symbols 52, 54, and 56 wins only and 25 credits buys all symbol wins. A flow chart applicable to this example of this embodiment of the invention is shown in FIG. 8 of the drawings. The game starts at step 300 and awaits selection by a player of a number of symbols (step 301). After a selection has been made the game 16 is played (step 302). In steps 303 and 305, the controller, instead of searching for any complete symbols and any special symbols that act as a substitute symbol, the controller 36 searches only for complete symbols of a type that was selected in step 301 and only for special symbols that are displayed with a part of a complete symbol that if complete would form a symbol of a type that was selected in step 301. In step 304, a symbol formed solely by special symbols is deemed to be a paying symbol.

In step 306 a count of the number of complete symbols of a type that has been selected in step 301 is made and in step 307 the controller 36 determines whether a prize is payable depending on the count made in step 306, which would typically involve comparing the number of complete symbols of each type with the paytable. In steps 308 and 309 any prize is paid and the game ends in the same way as steps 108 and 109 of FIG. 5.

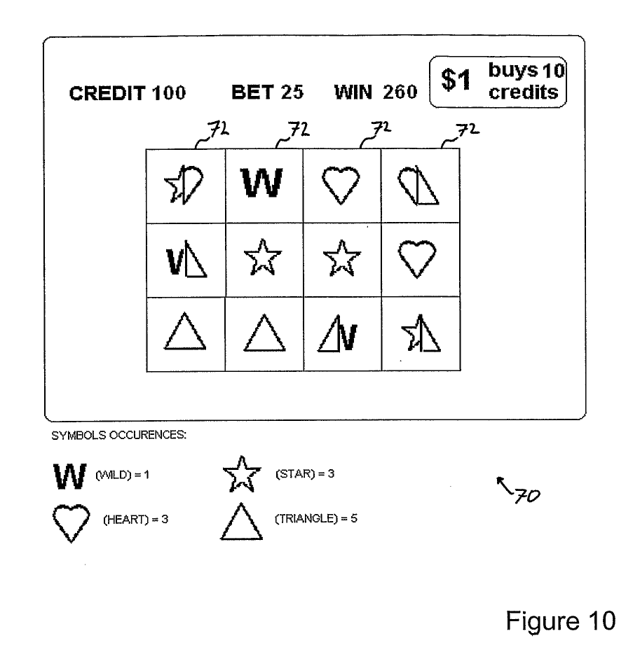

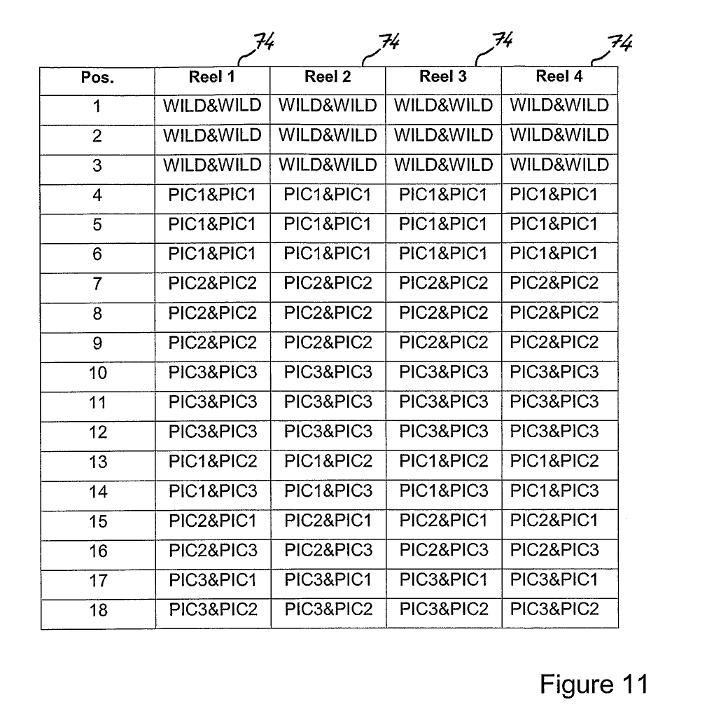

FIG. 10 shows a screen display 70 comprising four reels 72. Reel strips 74 associated with the reel 72 are shown in FIG. 11 of the drawings. Each reel strip 74 carries a column of formed symbols. A formed symbol is one made up of two symbol halves which may or may not match. It is to be noted that, for all intents and purposes, the screen display 70 will appear to a player very similar to the screen display 50 of the embodiment shown in FIG. 3 of the drawings.

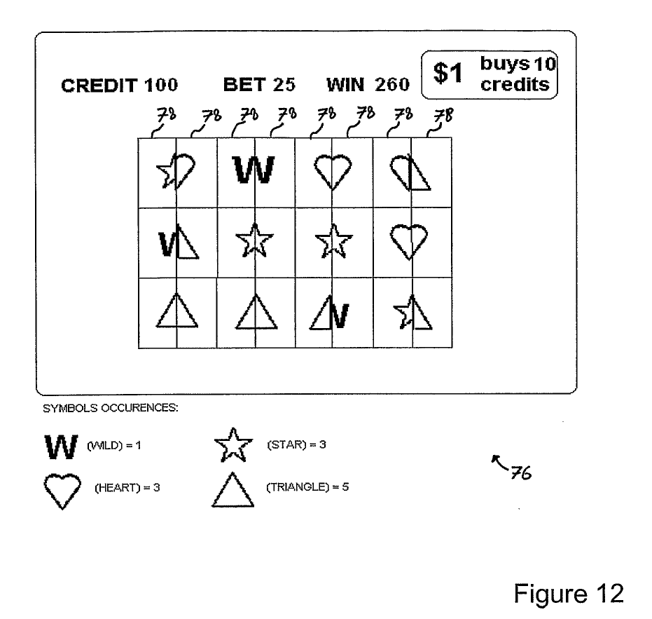

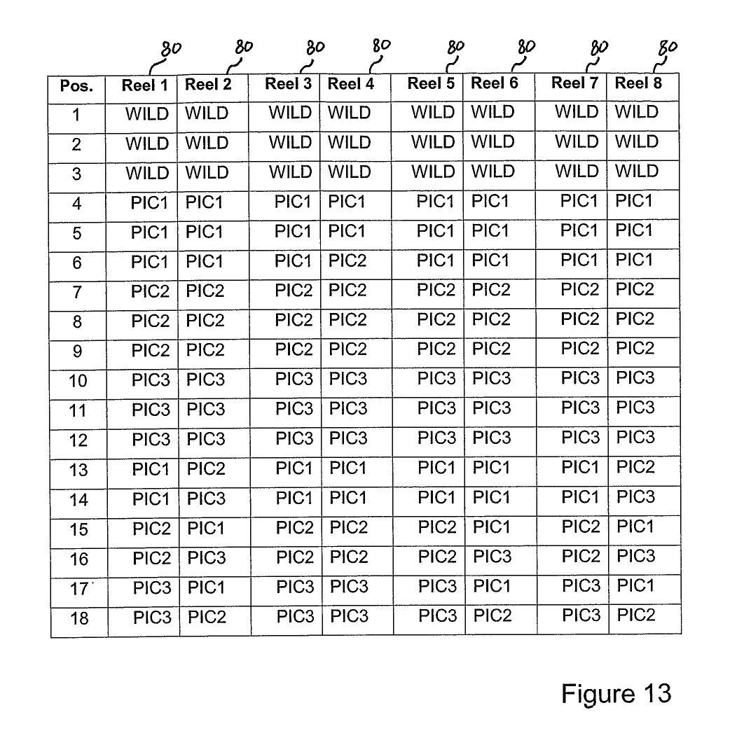

In FIG. 12 of the drawings, yet a further embodiment of a screen display 76 is shown. This screen display 76 comprises eight reels 78. Each reel 78 has a reel strip 80 (FIG. 13) associated with it. It will be noted that each reel strip 80 carries a single column of half symbols only as opposed to the formed symbols on the reel strips 74 of the FIG. 11 embodiment. Once again, the screen display 76 can be made to appear to a player to be the same as the embodiment shown in FIG. 3 of the drawings.

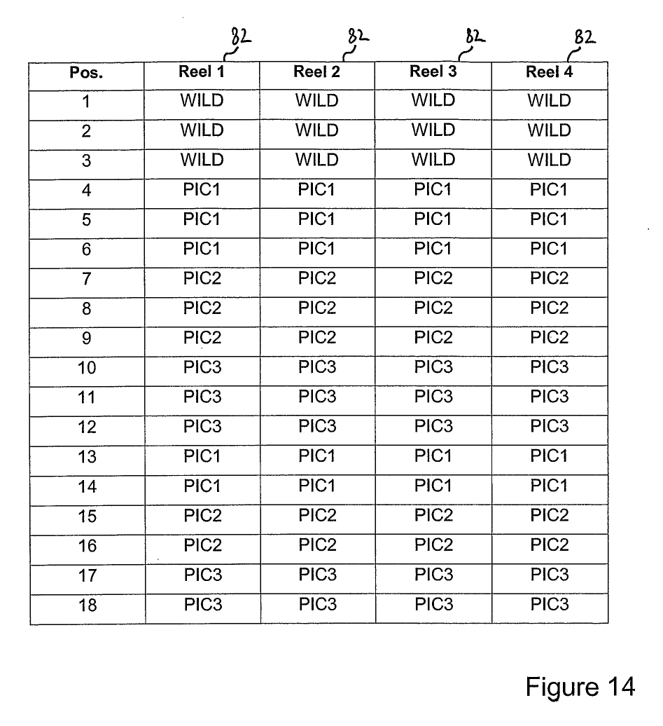

In the embodiment of FIG. 14 of the drawings, complete symbols are arranged on four reel strips 82. These four reel strips 82 map on to five underlying reels 18 so that the symbols overlap adjacent edges of neighbouring reels 18. When the reels 18 spin, the symbols on the reel strips 82 are split to provide the same effect as in FIG. 3 of the drawings.

While the invention has been described with reference to the symbol halves being carried on reel strips, it will be appreciated that this is not an essential feature of the invention. Thus, symbols could be generated at each of a plurality of display positions in a matrix on the screen. For example, one half of a symbol could be displayed at each symbol position to be followed, sequentially, by the displaying of a second symbol half at each display position in juxtaposition to the first half displayed at that position. Also, the symbol carriers could be arranged to move horizontally rather than vertically.

Further, while the invention has been described with reference to outcomes being in the form of complete symbols and prizes being awarded in respect of complete symbols formed, it will be appreciated that, like a conventional spinning reel gaming machine, prizes could be awarded for complete symbols occurring on paylines. Where symbols are generated at each display position “independently” rather than being carried into position on reels, it will be appreciated that vertical paylines could also apply.

Hence, it is an advantage of the invention that a gaming machine 10 is provided which has a unique appearance in comparison with other spinning reel type gaming machines and provides a unique technical effect. This technical effect is the generation of symbols at each display position by the combination of symbol parts.

It will be appreciated by persons skilled in the art that numerous variations and/or modifications may be made to the invention as shown in the specific embodiments without departing from the scope of the invention as defined in the appended claims. The present embodiments are, therefore, to be considered in all respects as illustrative and not restrictive.

1. A gaining machine comprising a display and a game controller to control play of a game on the gaming machine and control images displayed on the display in accordance with the game, the game comprising a plurality of symbols that are separated into a plurality of symbol sets, wherein for each symbol set a combined symbol is defined by the combination of a symbol from that symbol set with at least one symbol from at least one other symbol set but not with at least some other symbols from the at least one other symbol set, wherein during play of the game representations of the game are displayed on the display showing a random selection of at least one symbol from each symbol set, and wherein a prize is awardable only when at least one combined symbol is displayed on the display.

2. The gaming machine of claim 1, wherein the number of symbol sets is at least a factor of two of the number of symbols that form a combined symbol and a prize is awarded only when a plurality of combined symbols are displayed on the display.

3. The gaming machine of claim 1, wherein the game is a spinning reel game in which at least one symbol from a first symbol set of said plurality of symbol sets is spun up a first reel and at least one symbol from a second symbol set of said plurality of symbol sets is spun up on a second reel.

4. The gaming machine of claim 3, wherein each set of symbols is associated with a distinct reel of the spinning reel game.

5. The gaming machine of claim 3, wherein at least two symbol sets are spun up on the same reel and wherein a combined symbol is not be formed by any combination of symbols that are spun up on the same reel.

6. The gaming machine of claim 3, wherein there are N reels and 2N−2 symbol sets, where N is an integer and N>3.

7. The gaming machine of claim 3, wherein the game further has at least one pay line, wherein a prize is only awarded when said plurality of combined symbols are displayed on said at least one pay line.

8. The gaming machine of claim 1, wherein at least one of said plurality of symbols is a wildcard symbol and is deemed to form a combined symbol when displayed on said display with any other symbol of said plurality of symbols.

9. The gaming machine of claim 1, wherein the display of representations on the display showing a random selection of at least one symbol from each symbol set comprises showing at different times the selection for at least two symbol sets that can together form a combined symbol or a part thereof.

10. The gaming machine of claim 1, wherein the combined symbol is defined by the combination of two symbols and the plurality of symbol sets are separated into at least one pair of symbol sets, each pair of symbol sets consisting of a first set of symbols and a second set of symbols, and wherein a prize is awardable only when at least one combined symbol is displayed on the display, the combined symbol formed from two symbols within the same pair of symbol sets.

11. The gaming machine of claim 10, wherein the display of representations on the display showing a random selection of at least one symbol from said first set of symbols and a random selection of at least one symbol from said second set of symbols occurs sequentially for each of the pairs of symbol sets.

12. The gaming machine of claim 1, wherein a combined symbol is defined by the combination of at least three symbols, each symbol belonging to a separate one of said plurality of symbol sets.

13. The gaming machine of claim 1, wherein a combined symbol is defined by M symbols, and there are R symbol sets (R=nM, where n is an integer), and wherein the R symbol sets are divided into n groups and only symbols within the same group can form a combined symbol.

14. The gaming machine of claim 1, wherein a player of the gaming machine is allowed to select one or more of the combined symbols, wherein a prize is only awardable when at least one combined symbol that has been selected by the player is displayed on the display.

15. A game to be played on a gaming machine comprising a display and a game controller to control play of the game on the gaming machine, control images displayed on the display in accordance with the game and award a prize on the occurrence of predetermined events during play of the game, the game comprising a plurality of symbols that are separated into a plurality of symbol sets, wherein for each symbol set a combined symbol is defined by the combination of a symbol from that symbol set with at least one symbol from at least one other symbol set but not with at least some other symbols from the at least one other symbol set, the game causing the controller to display representations of the game on the display showing a random selection of at least one symbol from each symbol set and causing the controller to award a prize when the predetermined events occur, wherein every event in the predetermined events involves the display of at least one combined symbol on the display.

16. The game of claim 15, wherein the plurality of symbol sets are separated into pairs of symbol sets and a combined symbol is defined by the combination of a symbol from one symbol set in the pair with at least one symbol from the other symbol set in the pair but not with at least some other symbols from said other symbol set.

17. The game of claim 16 when displayed as a spinning reel type game, wherein each symbol set defines a reel strip for a spinning reel in the game.

18. A method of operating a game playing apparatus comprising a display and a game controller to control play of a game on the gaming machine and control images displayed on the display in accordance with the game, the method comprising defining plurality of symbols that are separated into a plurality of symbol sets, defining a combined symbol as the combination of a symbol from one of said plurality of symbol sets with at least one symbol from at least one other symbol set but not with at least some other symbols from the at least one other symbol set, with every one of said plurality of symbol sets having symbols in it that can form a combined symbol in the game, randomly selecting at least one symbol from each symbol set and showing representations of the selection on the display, and awarding a prize only when at least one combined symbol is displayed on the display.

19. The method of claim 18, wherein the plurality of symbol sets are separated into pairs of symbol sets and a combined symbol is defined by the combination of a symbol from one symbol set in the pair with at least one symbol from the other symbol set in the pair but not with at least some other symbols from said other symbol set.

20. The method of claim 19, wherein the step of showing representations of the selection on the display comprises showing representations of a spinning reel type game, wherein each symbol set defines a reel strip for a spinning reel in the game.

21. A gaming machine comprising a display and a game controller to control play of a game on the gaming machine and control images displayed on the display in accordance with the game, the game comprising a plurality of symbols that are separated into at least a first set of symbols and a second set of symbols, at least one symbol in each set comprising a combined symbol that is displayed as two or more matching symbol parts and the remainder of the symbols in each set comprising symbols that are displayed as having at least two symbol parts that do not match, wherein during play of the game representations are displayed on the display showing a random selection of at least one symbol from each said set of symbols, and a prize is awardable only when at least one combined symbol is displayed on the display.

22-24. (canceled)

25. The gaming machine of claim 10, wherein the number of symbol sets is at least a factor of two of the number of symbols that form a combined symbol and a prize is awarded only when a plurality of combined symbols are displayed on the display, and wherein the display of representations on the display showing a random selection of at least one symbol from said first set of symbols and a random selection of at least one symbol from said second set of symbols occurs sequentially for each of the pairs of symbol sets.

26. The gaming machine of claim 3, wherein the number of symbol sets is at least a factor of two of the number of symbols that form a combined symbol and a prize is awarded only when a plurality of combined symbols are displayed on the display, and wherein at least two symbol sets are spun up on the same reel and wherein a combined symbol is not be formed by any combination of symbols that are spun up on the same reel.
